(19) United States
(12) Patent Application Publication
(10) Pub. No.: US 2011/0196826 A1
(43) Pub. Date: Aug. 11, 2011

(54) Electronic Media Content Management System and Method of Operating an Electronic Media Content Management System

(75) Inventors: Francois Jacobus Retief, Somerset west (ZA); Leon Nortje, Boggomsbay (ZA); Ryan Dingley, Cape Town (ZA); Gerhard Esterhuizen, Cape Town (ZA)

(73) Assignee: IONO BROADCASTING (PROPRIETARY) LIMITED, Cape Town (ZA)

(21) Appl. No.: 13/125,468

(22) PCT Filed: Nov. 2, 2009
(86) PCT No.: PCT/IB2009/054852

§ 371 Date: Apr. 21, 2011

(30) Foreign Application Priority Data
Oct. 31, 2008 (ZA) 2008/09369

(51) Int. Cl. G06F 17/30

(52) U.S. Cl. 707/621; 707/E17.005

(57) ABSTRACT

An electronic media content management system is configured to communicate with at least one media player device associated with a user over a communication network. The system includes an updatable media content database or repository storing audio and/or visual content; a scheduling arrangement configured at least to receive a selected schedule of media content to be transmitted to the at least one media player device; and a synchronisation arrangement configured to transfer or transmit media content from the updatable media content database or repository to the at least one media player device in accordance with at least the selected schedule of media content.

### BACKGROUND OF THE INVENTION

THIS invention relates to an electronic media content management system and a method of operating the same.

It is a well established fact that a large proportion of the population is required to commute to work on a regular, if not daily basis. There are a vast amount of media and media sources, in particular audio related media material and sources available to consumers, particularly commuting consumers, to pass the time spent commuting more enjoyably or constructively. For example, commuters have the option of selecting one or more radio stations to listen to, listening to so-called “audio books” on audio cassette tapes or compact discs (CD), and listening to a selection of music stored on a mobile media player such as an iPod or the like.

There are, however, a number of difficulties associated with known media sources and material. For example, commuters who are exposed to a particular radio station for a longer period of time, in particular at different times of the day, may find the program material repetitive. It is also not possible to skip through broadcast content that is not of interest to the user, or to repeat content that the user may have missed. Furthermore, particular aspects of the program material may not appeal to a commuter who is then forced to listen to something they are not interested in or alternatively switch to a different station.

Likewise, repeatedly listening to the same “playlist” or music selection stored on an iPod or other media player, CD or cassette tape becomes boring and repetitive or the selection requires constant maintenance to keep it updated. In general, a shortcoming that all existing media sources of the abovementioned kind have in common is that the consumer does not have direct control over the types and variety of content to which they would like to be exposed during their commute.

Whilst a number of services are available through which consumers are able to subscribe to certain pre-defined content via the Internet which is then downloadable onto a particular mobile media player device, it still remains incumbent upon the consumer to continually update the pre-defined content by searching for new content on websites, to which they can subscribe, as well as managing the download and transfer of gathered content to their mobile device. Accordingly, there is a resulting lack of content diversity. Furthermore, a consumer may wish to listen to only some and not all of the content available by way of subscription but may be, nevertheless, forced to purchase the entire pre-defined offering, irrespective of their particular interest therein. Also one requires a fair amount of technical know-how in order to set subscription services up correctly and to have a working system.

It is an object of this invention to provide a media content management system that has advantages over many prior art systems.

### SUMMARY OF THE INVENTION

According to a first aspect of the invention there is provided an electronic media content management system configured to communicate with at least one media player device associated with a user over a communication network, the system comprising:
an updatable media content database or repository storing audio and/or visual media content;
a scheduling means configured at least to receive a selected schedule of media content to be transmitted to the at least one media player device; and
a synchronisation means configured to transfer or transmit media content from the updatable media content database or repository to the at least one media player device in accordance with at least the selected schedule of media content.

It will be appreciated that the schedule rule may preferably form part of the selected schedule for a particular user.

The system may comprise a user interface to facilitate the user accessing the electronic media content management system to at least select a schedule of media content.

The system may further comprise:
a content entry module configured to receive syndicated media content from at least one media content provider, and to store the received syndicated media content in the updatable media content repository; and
a content management module configured at least to, edit, delete, and transcode, according to transcoding rules, the stored media content in the updatable media content repository.

The content entry module may be configured to receive, and store in the updatable media content repository, transient and/or static media content from the at least one media content provider.

The static media content may comprise media content selected from a group comprising non-time sensitive media content, audio books, music, and podcasts. Whereas the transient media content may comprise media content selected from a group comprising content having an expiry timer, local and international news items, or podcasts.

The system may comprise a content catalogue which comprises information at least indicative of a list of media content stored in the updatable media content repository.

The scheduling means may be configured to receive, from the user via the user interface, a selected schedule of media content from the content catalogue.

The synchronisation means may be configured to transfer media content from the updatable media content repository to the at least one media player device in accordance with schedule rules, wherein the schedule rules comprise subscription rules and/or global schedule rules for the media content.

The scheduling means may be configured to receive schedule rules from the system, the user via the user interface, and/or an authorized third party, the schedule rules being arranged to assist the system to determine at least the media content to be transferred to the media content player from the updatable media content repository.

The content management module may be configured to:
receive, and store in the updatable media content repository, media content from the at least one content provider automatically in accordance with the schedule rules; and
initiate the synchronisation means to transfer media content to the media player device automatically also in accordance with the schedule rules.

The system may comprise a media player module located on the at least one media player device, the media player module being communicatively coupled to the synchronisation means to:
facilitate transfer of media content from the updatable media content repository to the at least one media player device; and
store the media content received from the updatable media content repository in a memory means of the media player device for access by the user.

The media player module may be configured to initiate the synchronisation means and request media content from the updatable media content repository in accordance with schedule rules.

The system may comprise a player configuration management module configured at least to monitor usage and/or status information associated with media content transferred to the user in accordance with the selected schedule of media content.

The status information comprises information indicative of the media content which has already been played, skipped, partially played by the user via the at least one media player device, or the time remaining for partially played media content.

The synchronisation means may be communicatively coupled to the player configuration management module thereby to use the monitored status information to determine the media content to be transferred to the at least one media player device.

The player configuration management module may be configured to use the monitored status information to determine which portions of the media content stored in the memory means of the at least one media player device has not been played as yet, skipped, partially played by the use, or the time remaining for partially played media content.

The player configuration management module may be arranged to manage media content and/or device configurations across a plurality of media player devices associated with the user.

The player configuration management module may be arranged to determine a bookmark at a particular point in the media content which the user uses on a first media player device such that, in use, if the user uses a second media player device associated therewith, the player configuration management module facilitates the user resuming using the media content from the bookmarked point in the media content on the second media player device substantially seamlessly.

The synchronisation means may further be configured:
for series-type content, to build a download list comprising meta data for episodes subsequent to a last episode transferred to the user; and
for news-type content, to build a download list comprising meta data that starts from a latest available episode and if desired at least one previous episode not yet received by the user.

The system may comprise a download log arranged to store information indicative of all media content transferred to the at least one media player device associated with the user.

The system may comprise an entitlement module configured to:
determine a financial value associated with the user for receiving media content; and
initiate the synchronisation means to transfer media content if the user has at least a predetermined financial value associated therewith.

According to a second aspect of the invention, there is provided a method of operating an electronic media content management system, the method comprising:
receiving at least syndicated media content from at least one media content provider;
storing the received media content in an updatable media content database or repository;
receiving a selection from a user indicative of at least information indicative of media content which the user desires to receive from the media content management system by way of a media player device associated with the user;
using at least the received selection from the user to generate a schedule of media content to be transmitted to the at least one media player device; and
transferring media content from the updatable media content database or repository to the at least one media player device in accordance with at least the schedule of media content.

The method may comprise receiving scheduling rules comprising at least subscription rules, the scheduling rules facilitating determination of at least media content retrieved from the updatable media content repository to be transferred to the media content player.

The method may comprise monitoring usage and/or status information associated with media content transferred to the user in accordance with the selected schedule of media content.

The status information may comprise information indicative of the media content which has already been played, skipped, partially played by the user via the at least one media player device, or the time remaining for partially played media content.

The method may comprise using the status information to determine the media content to transmit to the at least one or more media player device.

The method may comprise storing media content transferred to the media player device in a memory means of the media player device.

The method may comprise deleting stored media content from the media player device if:
the user indicates that the media content be deleted;
the user has already listened to and/or viewed the media content; and/or
more current media content of news-type media is available.

The method may comprise automatically deleting media content from the media payer device and/or the updatable media content repository.

The method may comprise optimizing the media content transferred to the media player device with respect to at least data quality, data size, media player constraints, and user preference/s.

Further features of the invention provide for the media content to be audio or video content; for content episodes with a logical sequence to be grouped underneath a channel, for channels or episodes with logical relation to be grouped underneath a category; for one or more schedules consisting of a selection of episodes, channels and categories as defined by the user; for the respective schedules to comprise a content list in which each content item has a specific sequence number which governs the priority in which the content will normally be downloaded to and played on the media player device

Further features of the invention provide for the media playing devices to constitute a mixture of one or more programmable devices with at least periodic connectivity to the Internet, for at least one of these devices to preferably be a mobile programmable personal device such as a Smartphone, PDA or portable PC, for other types of devices to include but not be limited to personal computers, bespoke platforms and programmable vehicle integrated devices; for the most current episodes associated with the respective schedules to be made available to this device either on request of the user or at predefined times prior to the user wanting the defined content to be available, for the episodes made available to the device to be governed both by the usage history on the device as well as the schedule rules sets and system policies.

Further features of the invention provide for the user interface to comprise a website interface; for the website interface to be accessible via the Internet and to include searching and filter facilities for searching through the media content contained in the repository by means of the content catalogue; for the website interface to include a registration facility in terms of which user's can log on to the website, create user accounts, subscribe to selected content and optionally provide payment details and the like. Still further features of the invention provide for the user to subscribe via the website to either free or paid content both current or future, associated with the selected channels or categories; for the user to obtain credits for payment via the website, a third party payment site such as PayPal, a premium rate short message service (SMS) or an online billing service provided by a cellular service or to be provide with credits by a third party; for credits to have different rules governing when they expire and what they may be exchanged for.

In accordance with an additional feature of the invention, the user may purchase content on a once-off basis via a premium rate SMS without the necessity of registration.

Further features of the invention provide for the scheduling means to comprise schedule management software; for the synchronisation means to preferably comprise the media player module which may be a software application installed on the mobile media player device to enable the device to use pull technology to request regularly updated content from the media content repository or repositories based upon the defined schedule that is being updated, the usage history of the device, the availability of subsequent or new content for the categories and channels included in the updating schedule, the availability of credits to pay for non-free content and other policies that governs synchronisation. The invention furthermore allows the user to modify this created list before download with respect to the list attributes already described, including the sequence of episodes and the number and composition of episodes to be downloaded.

A further feature of the invention may allow the system to optimize the audio content downloaded by the device with respect to quality, size, media player constraints and user preference.

### BRIEF DESCRIPTION OF THE DRAWINGS

FIG. 1 shows a schematic drawing of a network illustrating a system in accordance with an example embodiment;

FIG. 2 shows another schematic drawing of a network illustrating a system in accordance with an example embodiment;

FIG. 3 shows an illustration of an example schedule in accordance with an example embodiment;

FIG. 4 shows an illustration of a conceptual data model in accordance with an example embodiment of the invention;

FIG. 5 shows a flow diagram of a method in accordance with an example embodiment;

FIG. 6 shows a flow diagram of a method in accordance with an example embodiment for content updates; and

FIG. 7 shows a flow diagram of a method in accordance with an example embodiment for automatic content deletion.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

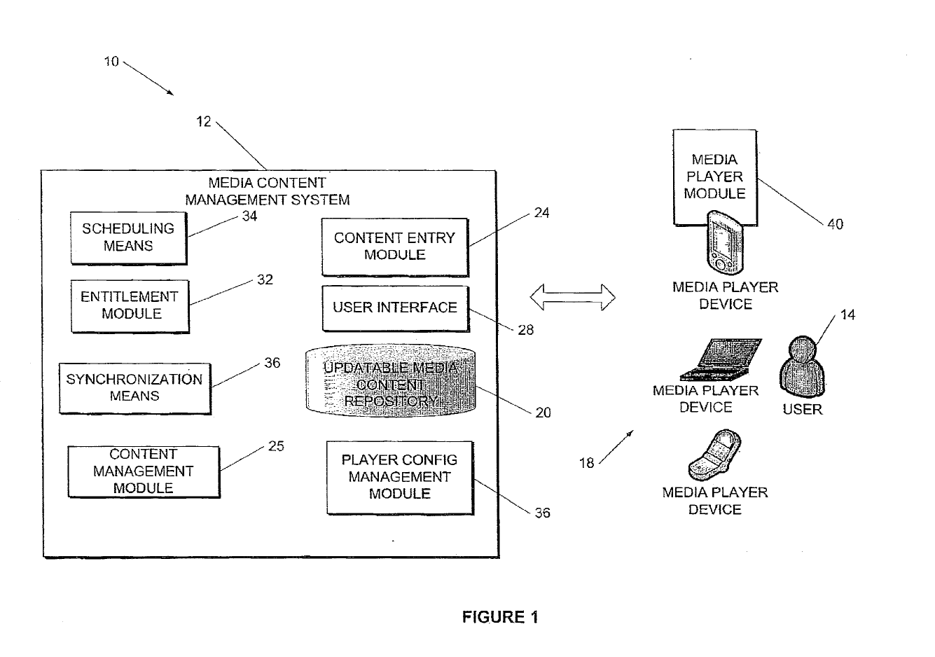

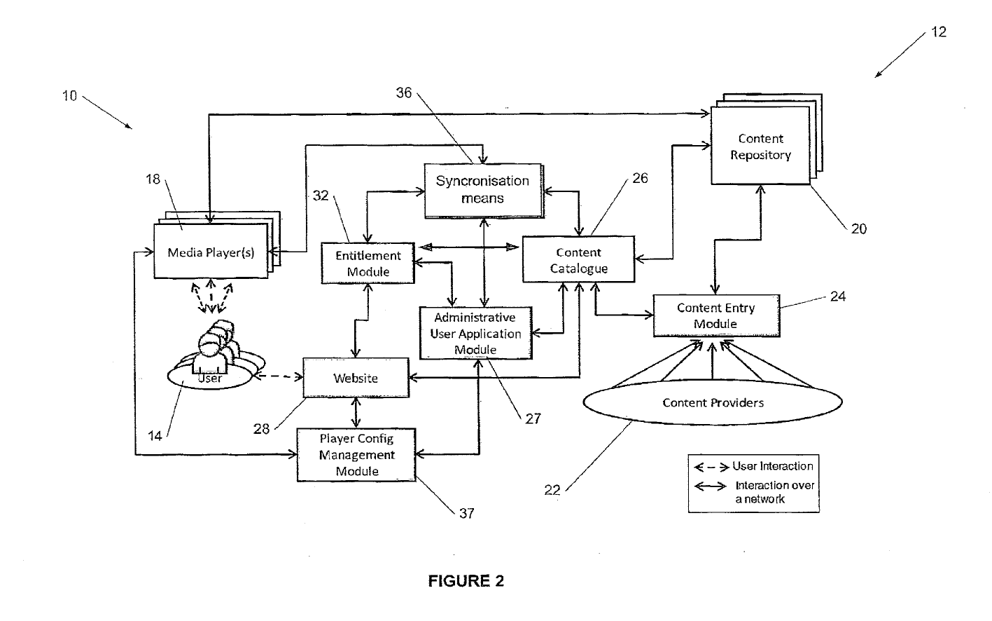

Referring to FIGS. 1 and 2 of the drawings, a network in accordance with an example embodiment is generally indicated by reference numeral 10. The network may conveniently be a distributed network comprising a media content management system 12 in accordance with an example embodiment. It will be appreciated that the systems 12 illustrated in FIG. 1 and FIG. 2 are similar and therefore similar parts will be indicated by the same reference numerals.

The system 12 allows users 14 of the system 12 to have direct control over the audio media content to which they are exposed. It has been identified that this problem particularly affects users 14 who spend substantial amounts of time busy with some activity that occupies them physically but not mentally. Examples include commuting, travelling or walking, exercising, or doing any kind of manual work.

The system 12 may comprise a plurality of components, means or modules which correspond to the functional tasks to be performed by the system 12. In this regard, means or module in the context of the specification will be understood to include an identifiable portion of code, a service, computational or executable instructions, data, or computational object to achieve a particular function, operation, processing, or procedure. It follows that a means or module need not be implemented in software; a means or module may be implemented in software, hardware, or a combination of software and hardware. Further, the means or module need not necessarily be consolidated into one device but may be spread across a plurality of devices for example with the network 10. Also, it will be appreciated that many of the functionalities provided by the various modules and means of the system 12 may overlap to provide the invention as herein described.

It will be noted that for the purposes of interpretation of this specification, in addition to their general meaning and/or further description herein, the words “Static media content” refers to such non-time sensitive material as audio books, music, podcasts and the like; where the value of the content does not diminish noticeably over time. “Transient content” refers to time sensitive content with a limited lifetime of normal usefulness. Transient content has an expiry timer at which point the normal value is generally deemed insignificant. Examples are various local and international news items. Some transient content may later be changed to static content, for example, a CNN transmission of the Mars landing.

“Episode” refers to a single content entity such as a single news bulletin file, a single podcast or a chapter in an audio book. “Channel” refers to a logical sequence of episodes such as a daily news bulletin, a podcast series or an audio book. “Category” refers to a group of channels with a logical relationship such as a group of channels that contains environmental news. “Schedule” refers to a prioritised sequence of content elements (episodes, channels or categories) that the user is interested it as well as related rules that governs how a download list is created from this list of content elements. “Download List” refers to a list of the prioritized episodes that represents the translation of a particular schedule at a particular point in time taking into account the content that is currently available as well as the user history. “Subscribed” refers to the user requesting the option to be able to receive new content of a particular type either as it becomes available (for example news updates) or as he has listened to previous content in the series (for example subsequent chapters in an audio book.) “New content” refers to episodes that will be made available on the system at some future time and date. “Subsequent Content” refers to episodes that are already available on the system but that has not been made available to the user previously. “Series type content” refers to a content stream where the user normally listens to episodes in a progressive sequence. Note that both transient or static media content may be listened to in series fashion. “Latest type content” or “News Type Content” refers to content where the user is normally more interested in listening to the most current episode than older episodes. “Web feed” refers to a data format used for providing users with frequently updated content on a subscription basis. “Podcast” means a series of audio or video digital media files which are distributed over the Internet by syndicated download through Web feeds to portable media players. “Web Syndicated” is a form of syndication in which website material is made available to multiple sites. Commonly, Web syndication refers to making Web feeds available from a site in order to provide other users with a summary of the website's recently added content. “Internet” is accorded its usual meaning of a global system of interconnected networks that interchange data by packet switching using the standardized Internet Protocol Suite (IP). “Website” means a collection of Web pages, images or videos or other digital assets that are hosted on one more web servers, accessible via the Internet. “Pull technology” involves computer network communication where an initial request for data originates from a client, such as a GSM enabled cellular telephone, to a server which request is then responded to by the server.

In any event, the system 12 is adapted to communicate over a communication network with one or more media player devices 18 per user 14. The devices 18 have enabling means for enabling it to communicate over the communication network. In this regard, the communications network may be a packet-switched network and may form part of the Internet. Instead, the communications network may be a circuit switched network, public switched data network, or the like. It follows that in an example embodiment, the elements of the system 12 advantageously reside in the communications network to provide functionality therefrom.

The system 12 includes one or more updatable media content repositories 20 of syndicated media content, in particular audio and video content, which is made available to the system 12 by one or more media content providers 22 (FIG. 2) and entered into the system 12 via a content entry module 24.

The content entry module 24 is advantageously arranged to receive media content from various content providers and store the same in the repository 20. In an example embodiment, the system 12 comprises a content management module 25 arranged to manage and/or maintain content in the system 12. The module 25 is configured to process media content creating master copies thereof, transcode master copies for distribution and lastly edit or delete content from the repository 20 of the system 12.

In any event, the content entry module 24 may be configured to receive and enter media content into the system in the following ways, for example:
1. One or more episodes are selected by the content management module 25 on a physical location such as a hard drive associated with the module 25 and uploaded into the system 12.
2. One or more internet download locations are specified by the content management module 25. The content entry module 24 automatically transfers the content into the system 12.
3. From monitored syndication updates such as RSS feeds for sites from which content is received, which is achieved by the content entry module 24 executing an associated script. Upon being notified that new content elements are available the module 24 is configured to enter the new content into the system 12 automatically.
4. From configured locations at configured times, automatically by executing an associated script, such as automated fetching from an FTP site.

Once content is in the system 12 it is processed either automatically as part of the associated script, as executed by the module 24, that entered it into the system 12, or manually via an administrative user application module 27 in combination with a content catalogue (mentioned below).

The content management module 25 is preferably arranged to transcode the media content, if and when desired, as described below. The correct meta data (Episode name, Episode Details, Duration, Cost, Channel, relationship, Category Relationships etc) are assigned to the content media and it is stored as a master copy.

In other example embodiments, there is a media transcoding component in the content catalogue (discussed below). In any event, the module 25 may be arranged to convert content to the optimum size. This is utilized in two places:
1. Uncompressed audio is converted to a lossless compression format such as FLAC before it is entered into the repository 20.
2. Repository master files are converted to the optimum format before it is made available for media players 18 to access.

In an example embodiment, the content management module 25 is configured to:
1. Evaluate rules for transcoding for a particular type of media content. These could be policies for master content or the types of devices 18 and quality policies of users 18 subscribed to that content.
2. Select the best supported media type based on the transcoding policies. For example, for mobile devices, the correct media format is selected from a number of options supported by the system 12. The decision is based on device capability, compression ratio and licensing costs Media types includes MP3, AAC, Speex FLAC, or the like.
3. Selecting the best transcoding quality level. It is desired to make the content file as small as possible without unacceptable loss of quality. This is primarily done by selecting the optimum bit rate but includes mechanisms such as converting two stereo channels into a single mono channel.

The level of compression varies but in a typical example a 57 MB MP3 encoded podcast of two hours may be compressed down to a 14.4 MB Speex file that is transferred in a quarter of the time and also does not incur any royalty costs.

Also, it will be appreciated that the content management module 25 may conveniently be arranged to edit or modify content in the repositories 20 or information in the content catalogue (discussed below) or to remove content that are no longer deeded valuable from the system 12.

The media content repositories 20 include transient and static content. The transient content comprises content that is constantly changing or updating, such as local and international news items and which has time expiry constraints. Static content comprises material which is not time constrained such as audio books and podcasts. A complete list of content in the repository or repositories is maintained in a Content Catalogue 26 (FIG. 2).

It will be noted that the media player devices 18 may be programmable devices that can communicate wirelessly over the Internet using HTTP, XML, FTP, RSS, and similar protocols. These include but are not limited to mobile computing devices or personal communications devices, Personal Digital Assistants (PDAs), Media Players, Lap Tops, Tablets, personal computers, programmable in-vehicle equipment or bespoke developed platforms. It shall also be possible to access the system 12 via desk-tops and RSS readers but it will be appreciated that the inherent limitations of these mechanisms shall prevent users 14 from experiencing the full benefits provided by the invention.

The user accesses the content catalogue 26 via a user interface 28, which will most commonly be in the form of a website accessible on the Internet. The website 28 includes searching and selection facilities by means of which the user 14 can search for and select the content of their choice for the purposes of subscribing to future content or to transfer content already in the repository (or repositories) 20 onto their mobile media player 18 for example. The user 14 is required to register on the website 28 at which time they are provided with an account activation link after providing requested information such as a username, e-mail address and country of residence. Once the user 14 has logged onto the website 28, they are able to select existing content or subscribe to future content either as specific content or content of the type or category in which they are interested, for example the Mail and Guardian's local and financial news, CNN's international news or a category of news bulletins and podcasts relating to environmental topics. In an example embodiment, the user interface 28 is a primary scheduling means (scheduling means is discussed below).

While much of the content will be free there will also be content that will have to be paid for. Credits may be purchased via the website interface, premium rated SMS or any other suitable billing service such as PayPal.

In this regard, it will be noted that the system 12 comprises an entitlement module 32 configured to determine a financial value or credit associated with the user 14 for receiving media content; and initiate transfer of media content if the user has at least a predetermined credit amount available. The module 32 also manages the process whereby a user 14 receives additional credits. This could be through a transaction that the user 14 initiates, through credits received from a third party, such credits received for listening to certain content or, for example, a company sponsoring certain content to employees or other mechanisms such as credits provided as a special promotion.

The user 14 may elect to do once off payments or opt for a monthly subscription fee. Different types of credits may have different rules relating to what kinds of content may be purchased with it, when it expires etc. Credits may expire after a certain time.

It follows that the entitlement module 32 is configured to handle all credit handling and financial details associated with the user 14.

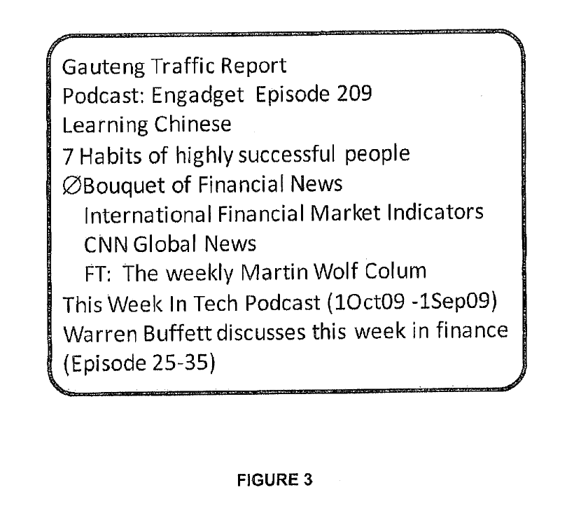

The system 12 preferably includes a scheduling means 34 configured at least to receive a selected schedule of media content to be transmitted to the media player device of the user 18. It will be appreciated that the means 34 may also be configured to receive scheduling information from the user 14 so as to generate the schedule. The means 34 is configured to receive one or more prioritized schedules from the user and/or an authorized third party as illustrated in FIG. 3. The user 14 or an authorized third party is able to configure schedules that contain a mixture of categories and channels in the priority sequence that content should preferably be made available. Schedules will be discussed in greater detail below. Rules for scheduling of new or subsequent content related to the schedules are also defined, either by the user 14, an authorized third party and/or by the system. This would include required episode ranges, the sequence in which new or subsequent episodes should be provided as well as the amount of content per channel or category that needs to be made available at any one time. The category scheduling rules cascades to channels and categories contained in the category, unless the user selects a sub channel or category and defines specific rules for it. The rules advantageously form part of the selected schedule of media content for the user 14.

Importantly, the system 12 includes synchronisation means 36 configured to transfer or transmit media content from the updatable media content database or repository 20 to the at least one media player device 18 in accordance with at least the selected schedule of media content. In other words, the means 36 is configured to facilitate transfer of the media content files conforming to the schedule rules to the mobile media player device 18 of a particular user 14.

In a preferred embodiment of the invention, the system 12 comprises a media player module 40 located at the at least one media player device 18, the media player module being communicatively coupled to the synchronisation means 36 to facilitate transfer of media content from the from the updatable media content repository 20 to the at least one media player device 18; and to store the media content received from the updatable media content repository 20 in a memory means of the media player device 18 for access by the user 14. The module 40 may comprise application software installed on the mobile media player device 18. The module 40 may allow the device 18 to facilitate synchronisation upon the software being started, the device 18 being switched on, upon request of the user 14, or automatically at set intervals provided the device 18 is switched on and able to connect to the Internet.

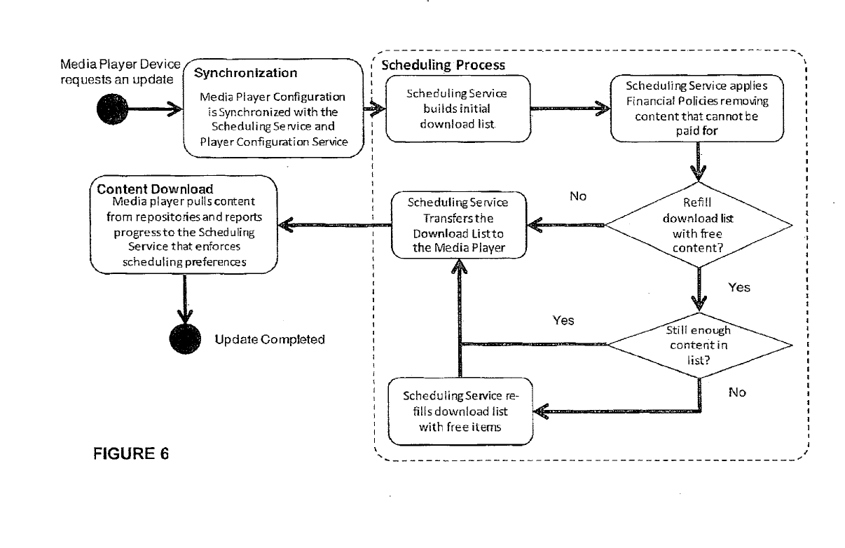

With reference to FIG. 6 of the drawings, as part of synchronisation the software communicates with a player configuration or config management module 37, exchanging usage and status information such as which content files on the user's schedule have been played or skipped, which content files are partially played, how much time remains for partially played content and the like.

It will be note that the user 14 is able to register more than one media player 18. In this regard, the player config management module 37 is configured to maintain device configuration across the multiple registered devices 14.

It follows that usage and status information from the previously used device will be incorporated into content management process as performed by the content management module 35. This will govern how the episode download list is constituted and what the device configuration should be.

As part of the operation of the synchronisation means 36, the means 34 may be arranged to operate the media player device to communicate with the player config management module 37 to ascertain if the user 14 has used another device 18 that has changed the global device configuration. Based on this status information received, the player 18 will configure the individual bookmarks for episodes the user is listening to in conjunction with other usage statistics. Bookmarks enable a user 14 to for example stop listening to one channel A on the device 18, listen to Channel B and then select Channel A, resuming from the point the user was last listening to Channel A. The device 18 may also update global user settings stored on the device, delete content in memory that was deleted by the user 14 while using a previous device and request content that was already uploaded to another user device but is not yet in the memory of this device 18.

Differently defined, or in another example embodiment, the player configuration management module 37 is arranged to determine a bookmark at a particular point in the media content which the user 14 uses on a first media player device 18 such that, in use, if the user uses a second media player device 18 associated therewith, the player configuration management module 37 facilitates the user 14 resuming using the media content from the bookmarked point in the media content on the second media player device 18 substantially seamlessly.

It follows that this allows the user 14 to seamlessly switch from one device 18 to another. For example, the user 14 may be listening to content on his home PC. Subsequently he may leave and start listening on a vehicle installed player. The player will continue from where he stopped listening on the PC. It will contain the same files that were on the PC when he stopped listening as well as subsequent and new content within the scheduling rules. The various bookmarks for partially listened elements will be transferred to the new platform. Any global configuration changes that were made on the previous platform will also be transferred.

It will be appreciated that the synchronisation means 36 is arranged to supply and list of episode meta data not owned by the user 14. Each episode entry contains a download location for that episode as well as meta data needed by the device to display and use the episode.

In any event it will be appreciated that the means 34 is configured to build a download list. The means 34 does this by firstly compiling a list of potential episodes to be downloaded based on the play list. Once this is done the list is filtered according to certain policy rule sets e.g. does the user 14 have enough credit to pay for the included episodes (as determined by the entitlement module 32) or is there is still enough bandwidth available within the limit the user 12 has set.

The scheduling means 34 is configured to build the initial download list as follows:

### A. Subscriptions

1. Retrieve a list of subscriptions (channels, episodes or categories).

2. Remove all inactive subscriptions.

3. Process the remaining subscriptions, in order of priority indicated by the user, as follows:

1. For a channel subscription, process according to B below.

2. For an episode subscription, process according to C below.

3. For a category subscription, process the channels in the category according to D below.

4. For a category subscription, process the episodes in the category according to E below.

### B. Channels

1. If a channel is inactive or belongs to an inactive provider, then do not schedule it.

2. Retrieve a list of episodes belonging to the channel, discarding those that are inactive (i.e. already expired or not yet published).

3. Select one or more episodes for inclusion in the schedule, according to the per-channel subscription configuration (e.g. direction, starting point, content duration required).

4. Process each selected episode according to the episode scheduling rules in C below.

### C. Episodes

1. If the episode is inactive, belongs to an inactive channel or belongs to a channel with an inactive provider, then do not schedule it.

2. If the user already listened to the episode due to this subscription, then do not schedule it.

3. If the episode is already present in the schedule, then do not schedule it.

4. Add the episode to the schedule.

### D. Categories (Channels)

1. Schedule the channel according to the channel scheduling rules in B above, with the following exceptions:

1. The category subscription effective date is substituted for the channel subscription effective date.

2. For channels that do not have explicit subscription preferences specified, the subscription preferences of the category are used instead.

### E Categories (Episodes)

1. Schedule the episode according to the episode scheduling rules in C above, with the following exceptions:

1. The category subscription date is substituted for the episode subscription date.

2. For episodes that do not have explicit subscription preferences specified, the subscription preferences of the category is used instead.

### F. General

1. A subscription is considered to be active if its expiry date is in the future and its effective date in the past.

2. A provider is considered active if it is flagged as such.

3. A channel is considered active if it is flagged as such.

4. An episode is considered active if its expiry date is in the future and its publication date in the past.

Once the initial download list is built, the scheduling means 34 is configured to apply various policy rule sets to it. These may include but are not limited to payment policies, download limits and mobile memory restrictions.

A payment policy is applied to the initial download list, for example by way of the entitlement module 32. Episodes in the download list are evaluated in priority sequence to determine if the user 14 has enough credits to pay for them. User configured rules are applied if the available amount of credits is not enough for all the candidate episodes. These could be to pay for all episodes under a schedule item in schedule item priority sequence, to divide the available credits evenly over all schedule items focusing on the highest priority episodes under each schedule item or additional rule sets. Special credits rules are also taken into account.

During the application of the payment policy rules content entries may be removed from the episode download list resulting in a list that contains less content than the user requested via the scheduling rules. If so configured, the synchronisation means 36 may be arranged to top this list up with the free content that the user 14 is also subscribed to.

The system 12 is configured to communicate with the media player device 18 information (for example, the episode download list) such as what content should be downloaded next, where the content files can be located on the content the server(s) and additional information needed to display and present the content via a web feed, at which point the files can be ‘pulled’ by the device 18 under control of the user 14 and made available using web file transfer protocol within the remaining policy constrains such as bandwidth allowances and available memory on the device 18. Download process status updates are provided to the scheduling means 34. This information is used to update the history of what content the user 14 has received as well as to deduct credits for content that is considered in possession of the user 14. The user 14 has the ability to modify this list before the content transfer process starts. If not yet available the transcoding service or content management module 25 creates the necessary content files, optimize it with respect to quality, size, media player constraints and user preference as hereinbefore described.

Episodes can be displayed on the device 18 in multiple predefined views according to the wishes of the user 14 for example a tree view with episodes listed under channels, a download priority view of episodes or a view with episodes sorted according to published age.

As previously mentioned, an important aspect of the system 12 is that it supports seamless integration of multiple devices 18 per user 14. Information exchanged as part of the synchronisation process includes status information such as what the user is listening to, bookmarks on different episodes, what content needs to be kept, what needs to be deleted, information on what content was on the previously used device that is not this one, etc. This status information is included into the scheduling mechanism to ensure that the user 14 can advantageously use one device 18 and then switch to another which will, providing device capability, have exactly the same state and continue from where the user 18 left the previous device.

There will be an option to stream content to web enabled devices like Personal Computers that are permanently connected to the internet and also to provide the episode download list in RSS format that will enable RSS readers and podcatchers to access the content. For the most part it is envisaged that the content will physically be stored on the device to ensure, that once downloaded, it is available whenever the user requires it unless otherwise deleted as outlined below.

The module 37 is conveniently arranged to delete media content from the device 18. It will be noted that to delete information from the device module 37 needs to communicate to the module 40 to effect the deletion unless deletion is handled on the media player device 18 in which case module 37 is part of module 40. Instead, or in addition, the module 40 is configured to delete data from the memory means of the device 18 in accordance with configurable rules which incorporate the following elements:
Content that has been marked by the user not to be deleted shall always be exempt from automatic deletion.
Content may be deleted once deleted once listened to.
Content that is designated news type content (as opposed to series type content) may be deleted once expired.
News type content may also be deleted if more current content of the same type is available.
Content may either be deleted as soon as the correct combination of deletion requirements are met, at the next synchronisation point or when space is needed on the device

The system 12 maintains a record or download log of all content that has been downloaded by the user 14, including content for which the user 14 owns a license.

To summarise, it will be noted that key elements of the invention are that:

1. The user 14 has control over what content he or she wants to listen to through the definition of the content schedule in conjunction with the defined data.

2. Automatic content management is done via synchronisation rules, system policies and automatic deletion rules. This ensures that especially content players 18 are automatically updated with new or subsequent episodes according the schedule set by user 14 through the defined synchronisation algorithms. This mechanism also provides the user 14 control over when content is updates and what type of transfer mechanism is used which provides cost benefit. Content management mechanisms are also extended through content deletion rules.

3. Prior to transfer content is transcoded into the optimum size, quality level and format depending on the medial player capability and the user requirements. This provides benefits in terms of transfer speed and cost, especially in environments where internet connectivity is slow or expensive.

4. Having content on the device allows the user 14 to listen to content when no Internet coverage is available, to skip sections that are not of interest, or more importantly, to repeat content if something was missed.

5. Interoperability allows the user to seamlessly switch between multiple content players and still have an integrated user experience.

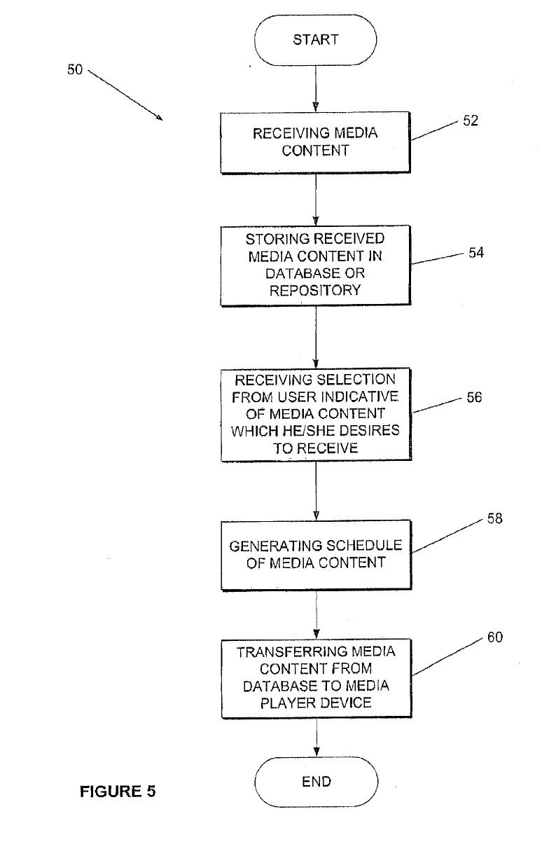

Example embodiments will now be further described in use with reference to FIGS. 5 to 7 (with FIG. 6 being previously described). The example methods shown in FIGS. 5 to 7 are described with reference to FIGS. 1 to 4, although it is to be appreciated that the example methods may be applicable to other systems (not illustrated) as well.

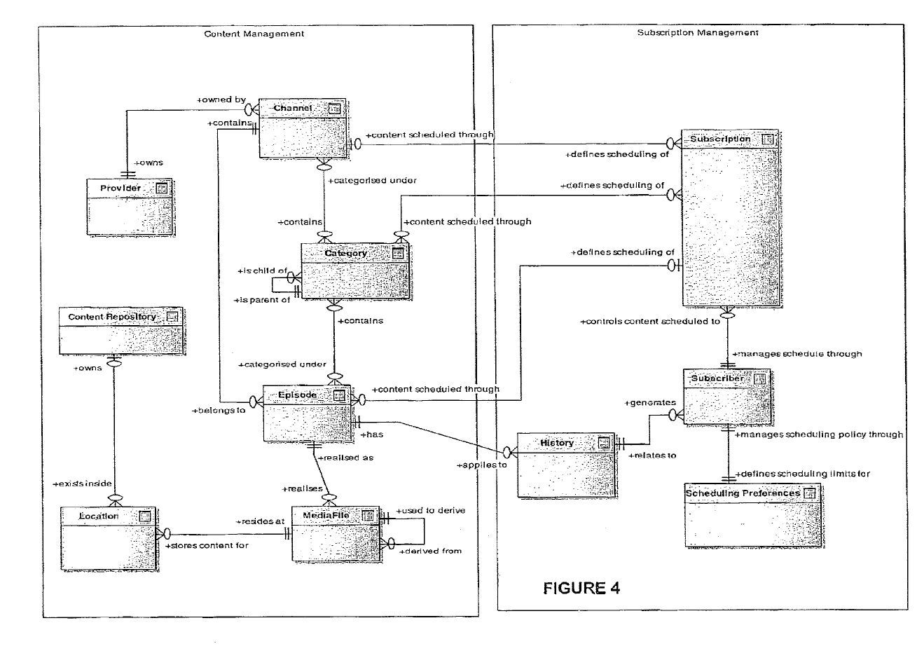

In any event, referring to FIG. 4, a flow diagram of a single iteration of a method for operating an electronic media content management system, for example the system 12, is generally indicated by reference numeral 50.

The method 50 comprises receiving, at block 52, at least syndicated media content from at least one media content provider.

The method 50 comprises storing, at block 54, the received media content in the updatable media content database or repository 20.

The method 50 comprises receiving, at block 56, a selection from a user 14 indicative of at least information indicative of media content which the user 14 desires to receive from the media content management system 12, via a media player device 18 associated with the user 14. The information received from the user may also comprise scheduling rules to determine media content handling as herein described.

The method 50 then comprises using, at block 58 for example by way of the means 34, at least the received selection from the user 14 to generate a schedule of media content to be transmitted to the at least one media player device 18. In this regard, it will be noted that method 50 may comprise merely receiving the schedule by way of the means 34.

In any event, the method 50 lastly comprises transferring, at block 60 via the module 38, media content from the updatable media content database or repository 20 to the at least one media player device 20 in accordance with at least the schedule of media content. It will be appreciated that the schedule may determine how and when the transfer of media content occurs.

It follows that for the schedule, media content is preferably classified in accordance with the data model illustrated in FIG. 4. In any event, for illustrative purposes, it will be noted that:

a. Content is made up of episodes that form part of a channel that is provided by a content provider. The following examples are provided:

| Content | | |
|---|---|---|
| Provider | Channel | Episode |
| CNN | CNN Daily | Episode 1: 8 Oct. 05 |
| | Financial News | Episode 2: 9 Oct. 5 |
| | | Episode 3: 10 Oct. 05 |
| | | Etc |
| CNN | CNN Hourly | Episode 1: 8 Oct. 05 |
| | World News | 6:00 |
| | | Episode 1: 8 Oct. 05 |
| | | 7:00 |
| | | Episode 1: 8 Oct. 05 |
| | | 8:00 |
| | | Etc |
| Victor Gollancz | Sourcery | Chapter 1 |
| Publishing, | | Chapter 2 |
| Great Britain | | Etc |
| Transworld | Thief of Time | Chapter 1 |
| Publishers, | | Chapter 2 |
| Great Britain | | Etc |

b. As defined particular content is either static or transient.

c. As defined transient content has an expiry timer

d. Each channel may also be part of one or more categories as the example below.

Note that categories may also be grouped under higher level categories:

| Category | Associated Channels |
|---|---|
| Terry Pratchett | Sourcery |
| Novels | Thief of Time |
| | Etc |
| Classic Fantasy | Sourcery |
| Novels | Thief of Time |
| | Lord of the Rings |
| | Etc |
| Fantasy Novels | Classic Fantasy Novels |
| | Futuristic Fantasy Novels |
| | Etc. |
| International | CNN Daily Financial News |
| Financial News | Forbes Weekly Financial Summary |
| | Etc |

e. Episodes, channels or categories can be combined to create one or more schedules. An example is illustrated in FIG. 3.

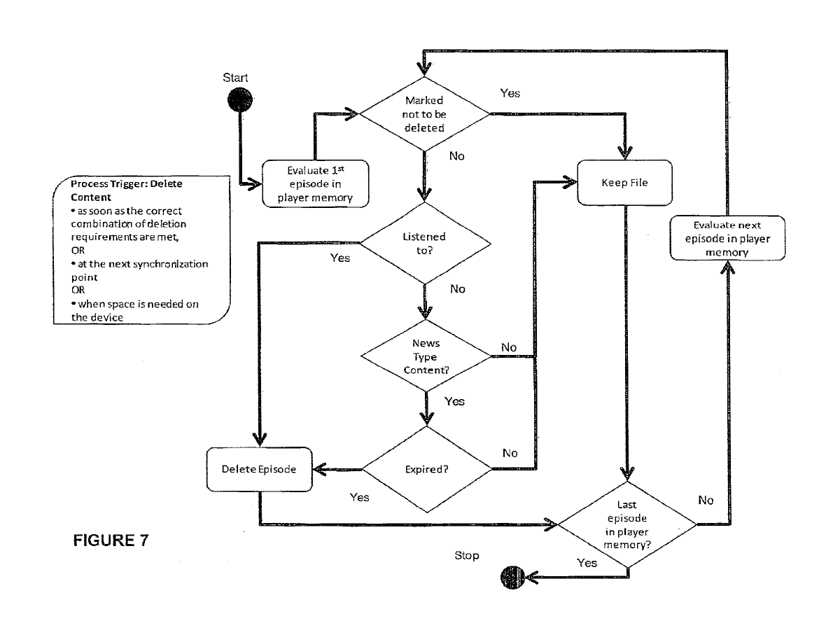

f. For each schedule entry additional scheduling rules is provided either by the user or by an authorized 3rd party such as an authorized administrator or defined policies on the scheduling server or website. The following rules are defined:
i. The sequence in which items are listed determines their priority.
ii. An item may be defined either as news type content or series type content. Series will be scheduled in sequential or first-in-first-out sequence. If it is news it will be downloaded in a last-in-first-our sequence.
iii. Rules may be defined as to the range of episodes that needs to be scheduled:
   1. Only one episode of interest may be scheduled, for example, episode 209.
   2. The user may want to listen to episodes 25 to 35 of a particular series, or from episode 300 onwards, or only until episode 120.
   3. The user may be interested in episodes that were published during a certain time period for example during the month of October 2009, or before a certain date, or after a certain date.
   4. If no rules are set it will be assumed that all content in the channel needs to be taken into account for scheduling, both existing and future.
iv. Rules as to the amount of content per channel or category are also defined. The user may require that there is always be at least 1 hour of content on his device. In this case the scheduler shall proceed down the list and attempt to fill the hour according to the defined rules or until there is no new or subsequent content available. It is however also possible to specify individual amounts for categories and channels. The user may for example require no more than 10 minutes of “Learning Chinese” per day but up 20 minutes of “7 Habits of highly successful people” and up to an hour of the Financial Bouquet.
v. Global Scheduling rules are a defined as series of rules specifying items such as:
   1. bandwidth allowances over specified time periods per transmission medium (e.g. not more than 800 MB of data per week via home WiFi and not more than 10 MB of data per day via GSM).
   2. maximum amount of storage that lono content may occupy on the device at any point in time.
vi Global Deletion Rules for all the content on the device are lastly defined:
   1. Content that has been marked by the user not to be deleted shall always be exempt from automatic deletion.
   2. Content may be automatically deleted once listened to.
   2. Content may be automatically deleted if it is news type content and it has expired.
   3. Content may be automatically deleted if it is news type content and it has not yet expired, but there is later content available and not enough space on the device for everything.
   As well as the trigger condition for automatic content deletion:
   1. Content may be deleted as soon as the correct combination of deletion requirements are met;
   OR
   2. Content may be deleted as part of synchronisation;
   OR
   3. Content may be deleted when more space is needed on the device.
   It will be noted that these steps are exemplified with reference to FIG. 7 of the drawings, which method may be performed by means 34 or 40 as the case may be.
vii. Subscription rules that is constituted out of one or more subscription lists containing:
   1. a prioritized series of subscription items (Category/Channel/Episode) each item with associated subscription rules:
      range of episodes to transfer,
      sequence of importance e.g. news or series, and
      amount of content required on device per subscription item.

g. The category scheduling rules cascades to channels and categories contained in the category, unless the user selects a sub channel or category and defines specific rules for it. For example a the category for financial news is selected and the range is set to episodes between certain dates that range will also apply to categories and channels contained within that channel.

h. Multiple schedules allow the user to select the optimum profile for specific situations e.g. a user may have a week day schedule, a special schedule for when he's on domestic business trips and a special schedule for when he or she is on vacation.

It will be understood that if the range requirements for the schedule item have been met the item may also be removed from the subscription once all the episodes have been successfully transferred to a registered user device or been deleted. As mentioned above, once the initial download list is built financial policy rules are applied to it.
a. A payment policy is applied to the initial download list. Episodes in the download list are evaluated in priority sequence to determine if the user has enough credits to pay for them. Episodes that cannot be paid for are removed from the list unless the user authorizes a top-up as part of the synchronisation process.
   i. User configured rules are applied if the available amount of credits is not enough for all the candidate episodes. These include:
      1. Continue to pay for all episodes under schedule item in schedule item priority sequence
      OR
      2. divide the available credits evenly over all schedule items focusing on the highest priority episodes under each schedule item
      OR
      3. divide the available credits focusing on newest content
      OR
      4. combinations hereof at the various hierarchical levels.
   ii. Special credits rules are also taken into account.
b. During the application of the payment policy rules content entries may be removed from the episode download list resulting in a list that contains less content than the user requested via the scheduling rules. If so configured the synchronisation means 36 can top this list up with the free content that the user is also subscribed to. For example: The user configured the system to attempt to ensure that there is up to 30 minutes of non-free episodes from channel A on the device. Let's say each episode is 10 minutes long. The user also requested up to 20 minutes of free episodes from Channel B, and 20 minutes free content from Channel C also both 10 minutes per episode. There is however a total daily download cap that translates to 40 minutes. If the user had enough credits to pay for all the Channel A episodes he would receive 3 episodes from Channel A and 1 from Channel B. But since the user only have enough credits to pay for 1 episode from Channel A (implying that the second and third episodes are removed from the download list) the Scheduling Manager tops the download list up with the two episodes from channel B and the first episode from Channel C.

It will be noted that limit policies are also applied against the download list to ensure that time period and/or transfer medium specific bandwidth allocations or allowable mobile memory limits are not exceeded.

In an example embodiment, the user 14 may exercise control over the download list before the download is started, changing sequence of elements or electing not to download elements (categories, channels and/or episodes. The user 14 may also exercise control over download constraints such as resetting bandwidth limits.

Note that this mechanism also provides the user control over when content is updated and what type of transfer mechanism is used which provides cost benefit. For example: A user 14 may set his device 18 up to download content during the night and dock it to his PC in the evening. During the night the device 18 will download all the content directly using cheap ADSL broadband. This is in contrast with a mechanism where the user 18 has to download content over GSM, resulting in high data costs. In another example, the user 14 may elect to only update on his command, which allows him to control which connection is used for example only downloading content when connected to his home or work WiFi connection. In a third example a user 14 may be on the road, He can review the episode download list on his device before the download starts to deselect items he's less interested in. He can also make changes to the normal sequence in which items are downloaded.

Content management mechanisms are also extended through content deletion rules as hereinbefore described.

An important aspect of the system is that the user 14 is able to listen to the content in any order and is not constrained to the order in which the content items appear on the schedule. In this way, the user 14 can skip through certain of the content and return to it later if so desired.

A particular feature of the invention is that audio or video content is automatically downloaded onto the user's mobile device 18 according to his or her configured wishes. Accordingly, the user 14 is not required to constantly search for the files of his choice, download them from the Internet to his or her PC and then synchronise with his or her mobile device 14. An important aspect of the invention is also the ability to, with mobile devices 14, utilize cost effective internet connections such as WiFi or being directly ‘docked’ to a PC and to download a sufficient amount of content to the device before the user 14 requires it.

It will be understood that the invention provides an extremely simple to use yet highly effective media content management system that has wide application potential depending on requirements. Also, numerous variations may be made to the embodiment of the invention described above without departing from the scope hereof.

1-31. (canceled)

32. An electronic media content management system configured to communicate with at least one media player device associated with a user over a communication network, comprising:
an updatable media content database or repository storing at least one of audio media content and visual media content;
a user interface operable by the user to access the electronic media content management system to create a schedule of media content, the schedule of media content identifying media which the user wishes to receive and defining at least one scheduling rule regulating transfer of the content to the user's media player device;
a scheduling arrangement configured at least to receive a selected schedule of media content to be transmitted to the at least one media player device; and
a synchronisation arrangement configured to one of transfer and transmit media content from the updatable media content database or repository to the at least one media player device in accordance with at least the selected schedule of media content, so that the media content is available whenever the user requires it.

33. The system of claim 32, further comprising:
a content entry module configured to receive syndicated media content from at least one media content provider and store the received syndicated media content in the updatable media content repository; and
a content management module configured at least to, edit, delete, and transcode, according to transcoding rules, the stored media content in the updatable media content repository.

34. The system of claim 33, wherein the content entry module is configured to receive, and store in the updatable media content repository, at least one of transient media content and static media content from the at least one media content provider.

35. The system of claim 34, wherein the static media content comprises media content selected from a group comprising non-time sensitive media content, audio books, music, and podcasts.

36. The system of claim 34, wherein the transient media content comprises media content selected from a group comprising content having an expiry timer, local and international news items, or podcasts.

37. The system of claim 32, wherein the system comprises a content catalogue which comprises information at least indicative of a list of media content stored in the updatable media content repository.

38. The system of claim 37, wherein the scheduling arrangement is configured to receive, from the user via the user interface, a schedule of media content selected from the content catalogue.

39. The system of claim 33, wherein the synchronisation arrangement is configured to transfer media content from the updatable media content repository to the at least one media player device in accordance with schedule rules, wherein the schedule rules comprise subscription rules and/or global schedule rules for the media content.

40. The system of claim 39, wherein the scheduling arrangement is configured to receive schedule rules from at least one of the system, the user via the user interface, and an authorized third party, the schedule rules being arranged to assist the system to determine at least media content the media content to be transferred to the media content player from the updatable media content repository.

41. The system of claim 39, wherein the content management module is configured to:
receive, and store in the updatable media content repository, media content from the at least one content provider automatically in accordance with the schedule rules; and
initiate the synchronisation means to transfer media content to the media player device automatically also in accordance with the schedule rules.

42. The system of claim 32, further comprising:
a media player module located on the at least one media player device, the media player module being communicatively coupled to the synchronisation arrangement to:
facilitate transfer of media content from the updatable media content repository to the at least one media player device; and
store the media content received from the updatable media content repository in a memory arrangement of the media player device for access by the user.

43. The system of claim 42, wherein the media player module is configured to initiate the synchronisation arrangement and request media content from the updatable media content repository in accordance with schedule rules.

44. The system of claim 42, further comprising:
a player configuration management module configured at least to monitor usage or status information associated with media content transferred to the user in accordance with the selected schedule of media content.

45. The system of claim 44, wherein the usage or status information comprises information indicative of one of (a) the media content which has already been one of played, skipped, and partially played by the user via the at least one media player device, and (b) the time remaining for partially played media content.

46. The system of claim 44, wherein the synchronisation arrangement is communicatively coupled to the player configuration management module thereby to use the monitored usage or status information to determine the media content to be transferred to the at least one media player device.

47. The system of claim 44, wherein the player configuration management module is configured to use the monitored usage or status information to determine one of (a) which portions of the media content stored in the memory arrangement of the at least one media player device has not been played as yet, skipped, partially played by the use, and (b) the time remaining for partially played media content.

48. The system of claim 47, wherein the player configuration management module is arranged to at least one of manage media content and device configurations across a plurality of media player devices associated with the user.

49. The system of claim 48, wherein the player configuration management module is arranged to determine a bookmark at a particular point in the media content which the user uses on a first media player device such that, in use, if the user uses a second media player device associated therewith, the player configuration management module facilitates the user resuming using the media content from the bookmarked point in the media content on the second media player device substantially seamlessly.

50. The system of claim 44, wherein the synchronisation arrangement is configured:
for series-type content, to build a download list comprising meta data for episodes subsequent to a last episode transferred to the user; and
for news-type content, to build a download list comprising meta data that starts from a latest available episode and if desired at least one previous episode.

51. The system of claim 32, further comprising:
a download log arranged to store information indicative of all media content transferred to the at least one media player device associated with the user.

52. The system of claim 32, further comprising:
an entitlement module configured to determine a financial value associated with the user for receiving media content; and initiate the synchronisation means to transfer media content if the user has at least a predetermined financial value associated therewith.

53. A method for operating an electronic media content management system, comprising:
receiving at least syndicated media content from at least one media content provider;
storing the received media content in an updatable media content database or repository;
receiving a selection from a user indicative of media content which the user desires to receive from the media content management system by way of a media player device associated with the user;
using at least the received selection from the user to generate a schedule of media content to be transmitted to the at least one media player device, the schedule of media content identifying media which the user wishes to receive and defining at least one scheduling rule regulating transfer of the content to the user's media player device; and
transferring media content from the updatable media content database or repository to the at least one media player device in accordance with at least the schedule of media content, so that the media content is available whenever the user requires it.

54. The method of claim 53, further comprising:
receiving scheduling rules comprising at least subscription rules or global scheduling rules, the scheduling rules facilitating determination of media content retrieved from the updatable media content repository to be transferred to the media content player.

55. The method of claim 53, further comprising:
monitoring usage or status information associated with media content transferred to the user in accordance with the selected schedule of media content.

56. The method of claim 54, wherein the usage or status information comprises information indicative of one of (a) the media content which has one of already been played, skipped, and partially played by the user via the at least one media player device, and (b) the time remaining for partially played media content.

57. The method of claim 56, further comprising:
using the status information to determine the media content to transmit to the at least one or more media player device.

58. The method of claim 53, further comprising:
storing media content transferred to the media player device in a memory arrangement of the media player device.

59. The method of claim 58, further comprising:
deleting stored media content from the media player device if one of (a) the user indicates that the media content be deleted; (b) the user has at least one of already listened to and viewed the media content; and (c) more current media content of news-type media is available.

60. The method of claim 59, further comprising:
automatically deleting media content from at least one of the media payer device and the updatable media content repository.

61. The method of claim 53, further comprising:
optimizing the media content transferred to the media player device with respect to at least data quality, data size, media player constraints, and user preferences.
